(19) United States
(12) Patent Application Publication
(10) Pub. No.: US 2025/0292338 A1
(43) Pub. Date: Sep. 18, 2025

(54) SYSTEM AND METHOD FOR ENHANCING SPORTS FAN ENGAGEMENT THROUGH A MOBILE APPLICATION

(71) Applicants: Ahmed Imam, Chandler, AZ (US); Amir Imam, Chandler, AZ (US); Adnan Gumel, New York, NY (US); Ashraf Babiker, Dubai (AE); Ibrahim Farah, Dubai (AE)

(72) Inventors: Ahmed Imam, Chandler, AZ (US); Amir Imam, Chandler, AZ (US); Adnan Gumel, New York, NY (US); Ashraf Babiker, Dubai (AE); Ibrahim Farah, Dubai (AE)

(21) Appl. No.: 19/077,709

(22) Filed: Mar. 12, 2025

Related U.S. Application Data
(60) Provisional application No. 63/564,413, filed on Mar. 12, 2024.

(51) Int. Cl. G06Q 50/00; G07F 17/32

(52) U.S. Cl. CPC G06Q 50/01; G07F 17/3255

(57) ABSTRACT

The invention provides a method for driving fan interactions with a sports club through a mobile application. Users may enroll and be indexed as fans of one or more clubs. Periodic quizzes based on information relevant to the club are provided to each user indexed as a fan of the club, and points awarded based on quiz results that may be used for entries in a raffle for club prizes. Influencers may enroll and live stream during matches, creating interactive content for viewers. The club page and league page are managed by official accounts that can upload relevant content and follow or unfollow users. Quiz content may be based on visual content from game and generated through artificial intelligence machine learning. Club prizes can include tickets to an upcoming club match, signed club apparel, and interactions with club players. The raffle can be broadcasted live on a media channel.

### BACKGROUND OF THE INVENTION

### Field of the Invention

This invention pertains to methods and systems for enhancing fan engagement with sports, particularly through the use of a mobile application that facilitates interactive activities such as quizzes, raffles, and live streams. The invention further relates to the use of artificial intelligence in generating quiz content and the integration of various user roles such as club users, player users, and influencer users.

### Description of Related Art

Sports clubs and their leagues are constantly working to increase fan engagement and loyalty. Traditionally, this has been achieved through physical attendance at games, purchasing of club merchandise, and following club news through various media outlets. However, with the advent of digital technology, there is a growing need for more interactive and engaging platforms that can foster a deeper connection between fans and their favorite sports clubs. Players are also constantly seeking new ways to engage with their fans and increase their own personal brands.

Mobile applications have emerged as a powerful tool for fan engagement, providing a platform where fans can access club news, player profiles, match schedules, and other relevant information. However, most existing applications offer a passive experience, where fans are merely consumers of information. There is a need for a more interactive platform that can actively engage fans, stimulate their knowledge of the club, and reward their loyalty.

Furthermore, the rise of social media influencers and their impact on fan behavior presents an opportunity for sports clubs to leverage these influencers in driving fan engagement. There is a lack of platforms that effectively integrate influencers into the fan engagement process.

Additionally, the use of artificial intelligence in content generation is a growing trend. However, its application in the context of sports club fan engagement, particularly in the creation of quiz content, is largely unexplored.

Therefore, it is desirable to provide a method and system that addresses these gaps, offering an interactive, engaging, and rewarding experience for sports club fans, while effectively integrating various user roles and leveraging artificial intelligence for content generation.

To reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a method of driving fan interactions with a sports governing association, a sports continental confederations, a sports national association, leagues, or a sports club using a digital platform such as a mobile application that is integrated with a team's game broadcasts. Fans that actually watch each game in a given time period are given enhanced opportunities to win prizes including game tickets, direct interactions with players and unique club merchandise.

Traditional sports engagement platforms typically focus on limited aspects of fan interaction and frequently lack integration with local sports ecosystems, resulting in fragmented fan experiences and inefficient operational procedures for sports organizations. In some aspects, the present invention serves as an all-in-one aggregator to engage fans and connect them with local sports stakeholders in a way that is specifically tailored to domestic market dynamics. The platform acts as a central repository where all sports of wide variety can be represented through various user communities based on shared interests, such as favorite teams. The system may function as an advanced customer relationship management tool for government-related and private sports entities, providing a unified database that can be scaled across multiple geographical regions, from a single country to multiple interconnected regions.

The platform provides a User Interface (UI) Component and a Back Engine Component. The UI component provides a front-facing interactive system accessible to end users including sports fans and stakeholder representatives and the Back-Engine Component serves as a comprehensive administrative and configurational system that manages all interactive data, educational content, and authentication processes. This Back-Engine enables stakeholders to configure and manage various aspects of the platform through a tabulated interface.

It is an object of the invention to increase engagement between a sports club and fans.

It is another object of the invention to allow a league of sports teams to drive fan engagement with clubs in a league.

It is another object of the invention to reward fans prizes by awarding points to fans that are able to answer questions about sport clubs, the clubs players, or the clubs league.

It is another object of the invention to reward fans for watching games by awarding points to fans that are able to answer questions about a recent game broadcast.

It is another object of the invention to provide a platform for users to upload videos recorded during games to generate quiz questions and to increase platform engagement.

It is another object of the invention to provide a platform showing pictures, scenes or videos reflecting their location while attending games or visiting sports venues to increase platform engagement.

It is another object of the invention to provide a platform for showing pictures, scenes or videos reflecting users at sport venue localities to increase platform engagement.

It is another object of the invention to provide a platform for users to vote for a choice from among different sport event options including but not limited to the events managed by the league.

It is another object of the invention to provide a platform for users to vote for a choice from among different live match options including but not limited to man of the match and best goal examples.

It is another object of the invention to provide a platform for users to bid using their attained weekly or monthly points for a choice from among different sport event options.

It is another object of the invention to provide a platform for users to bid using their attained weekly or monthly points for a choice from among different event options including best player of the week or month, best goal of the week or month, best coach of the month, and best team of the month but not limited to the events managed by the league.

It is another object of the invention to provide a platform for users showing the voting or the bidding outcomes in graphical format.

It is another object of the invention to reward fans for watching games by awarding points to fans that are able to vote during a live game broadcast. It is another object of the invention to provide a platform for influencers to engage fans with live or passive video content during games.

It is another object of the invention to provide a platform for a sport club's super fans to engage the club's other fans with live or passive video content before, during, after games.

It is another object of the invention to facilitate clubs in a league being able to schedule promotional events between the teams in the league.

It is another object of the invention to provide additional revenue streams for sport governing association, sport continental confederations, sport national associations, leagues, sports clubs, players, and influencers.

It is another object of the invention to provide an in-app marketplace offering exclusive apparel to fans.

It is another object of the invention to provide a better fan experience for fans of sports clubs.

It is another object of the invention to provide a blend of entertainment media, fan-celebrity engagement, and sports business.

It is another object of the invention to involve popular regional social media influencers to add hype to the platform.

It is another object of the invention to manage user, team, league, and influencer profiles to streamline fan engagement.

The above and other objects may be achieved using a method involving the use of a mobile application that features at least one club page. Each club page contains information relevant to a specific club. The application allows a multitude of users to enroll and use the application. Each user is indexed as a fan of at least one of the clubs featured on the application.

The method further involves providing a periodic quiz to users on the platform. The quiz may be generated by artificial intelligence machine learning. And may be based on information relevant to a club, a match, or the league to which the club or game competition belongs. The information relevant to the club may be related to players that play for the club, personnel of the club, history of the club, recent game results for the club, and club branding and marketing materials. The quiz may include a photo or video clip captured from a match and asking which game the clip is from or asking for information relating to the interaction depicted in the photo or video clip. The quizzes may be daily during the sports season.

Users are awarded points based on the results of the periodic quiz. Users may also be awarded points based on a subscription that gains them additional points or additional opportunities to earn points. Users may earn points for everyday interactions: creating posts, commenting on others' updates, or participating in admin-created trivia. These points are tallied within user profiles, introducing a level of gamification that goes beyond the standard “likes” and “follows.” The number of points earned by the user entitles the user to entries in a raffle for club related prizes. The club prize may be tickets to an upcoming club match, signed club apparel, or face-to-face or live chat interactions with club players.

The method also includes allowing users to use the platform, to vote for a choice of at least one of a sport event or a live match option or may provide other live polling options. The live match option can be at least one of a man of the match, a best goal, a best play, a best comment, or a best broadcast moment. This feature allows users to have a say in the events and moments that are highlighted in the application. The method further includes allowing users to bid awarded points for a choice of event options. The live event options can include best player over a time period, best goal of a time period, best coach over a time period, or best team over a time period. This feature allows users to use their points in a competitive and engaging way. The method also includes allowing users to predict a live event option. This feature allows users to engage with the application and the club in a predictive and strategic way.

At least one of the clubs may sponsor a raffle and provide the club prize. A schedule may be provided for clubs to sponsor raffle prizes. The method may also include a weekly schedule of quiz challenges, which includes having a daily quiz on Monday through Thursday, announcing winners on Friday, and awarding prizes on Saturday. The method may also include broadcasting the raffle or showcasing the different winners live on a media channel.

In some embodiments, the club is a member of at least one league. Each league has a league page, and users who are fans of a club in the league are indexed as fans of the league. The club page may have a club user, which is an official account that manages the club profile, uploads club video and news, and is enabled to follow or unfollow users on behalf of the club.

Players who play for a club may apply for a player user account that is an official account for players that play for a club. Similarly, influencers may enroll as an influencer user by applying for an influencer account. Player and influencer users are vetted by administrators before being granted a player or influencer account. Influencers may be enabled to live stream during matches for a club and link the live stream to the club page of the club. The influencer may create questions for viewers of the live stream and award points for correct responses. In some embodiments, the league page has a league user that is an official account that manages the league profile, uploads league video and news, and is enabled to follow or unfollow users on behalf of the league.

In conclusion, the present invention provides a method for driving fan interactions with a sports club through a mobile application. This method enhances fan engagement by providing relevant club information, quizzes, and opportunities to win club prizes. The method also allows for increased interaction between fans, clubs, players, and influencers.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a user flow diagram according to one or more embodiments of the invention.

FIG. 2 depicts a view of the backend engine according to one or more embodiments of the invention.

FIG. 3 depicts the view of the backend engine according to the embodiments of FIG. 2 with the left hand column scrolled down.

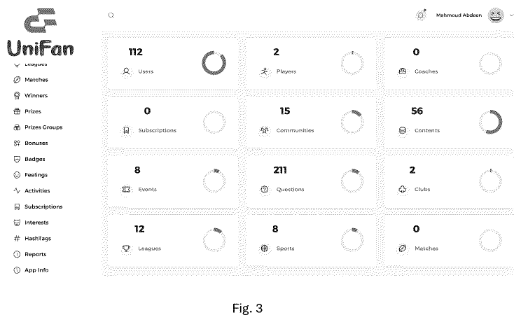

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

In one application of the invention, a method involving the use of a mobile application that features at least one club page is provided. Each club page contains information relevant to a specific club. Relevant information may include game schedules, player rosters, video clips, media stories about the team, press releases, influencers, and other information. The club page may be run or curated by the club or an official representative of the club, or may be an automated aggregation of information related to the club. The club page may have a club user, which is an official account that manages the club profile, uploads club video and news, and is enabled to follow or unfollow users on behalf of the club.

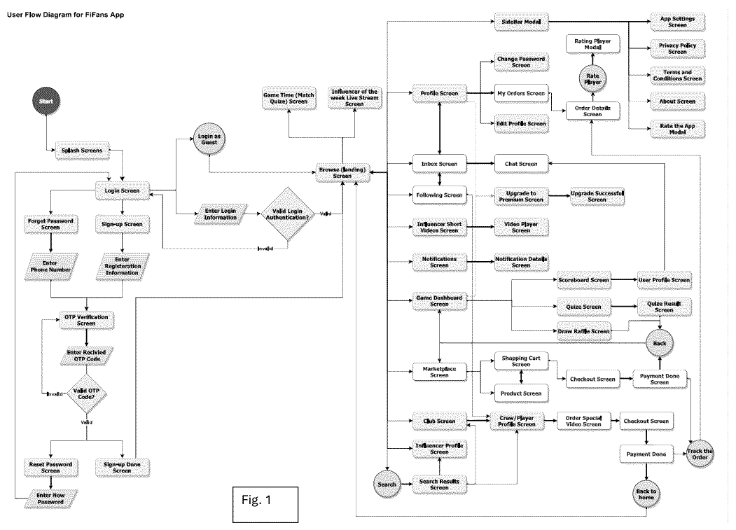

The application allows a multitude of users to enroll and use the application. Each user is indexed as a fan of at least one of the clubs featured on the application. A sample user flow diagram for one embodiment of the invention is shown in FIG. 1. Upon downloading and opening the platform, users will be required to create an account. User registration may create a profile having a short bio for the user, the user's favorite team or players, and user created content.

Users may be offered a free account option and a premium membership option that is available for a fee. A landing page may be provided where users can register their accounts upon opening the platform. Features may include a payment gateway that will connect registered users' accounts to a banking system via an API and an influencer of the week which may include two social media influencers, each of whom will rally behind opposing teams.

Users may have a news and highlights feed. The user interface (UI) may include a feed with the latest news concerning the user's teams or the league that the user follows event. For example, for the case of Saudi Arabia, the Saudi Pro League and the football world in general. This may include an API system displaying headlines and articles from popular news or sports media platforms, such as the Canal+, beIN Sports, MBC, ESPN, LaLiga, or BBC. The media choice depends on the user language choice from the list of available languages. In-app social media may be available for users to interact with each other through a messaging system and a feed consisting of messages. Games may be broadcasted directly through the application to fans.

Users may message with other users an receive in-app notifications. Notifications trigger whenever someone is tagged in a post, a new trivia round launches, or a fan's content receives likes or comments. This consistent update stream keeps participants engaged in real time. Users can manage how frequently they receive alerts, ensuring they stay informed without feeling overwhelmed.

The method further involves providing a periodic quiz to users on the platform. The quiz may be generated by artificial intelligence machine learning and may be based on information relevant to the club. The information relevant to the club may be related to players that play for the club, personnel of the club, history of the club, recent game results for the club, and club branding and marketing materials. The quiz may include a photo or video clip captured from a recent match and asking which game the clip is from or asking for information relating to the interaction depicted in the photo or video clip. For example, the artificial intelligence engine (AIE) may take a moment from a match that occurred recently during which fan comments spiked during the original broadcast. The AIE may make a clip from that moment of the match and the quiz would ask users some aspect about the captured moment.

The quizzes may be daily during the sports season or may occur during a live event such as a game. For example, for the daily skill contest, users may answer three (or some other number) of randomly AI-generated questions. Depending on whether the user is a basic or premium member, the user may have access to additional questions. For live event questions, a question may be during the halftime of a game and could be relevant to some occurrence, players actions, or stats that happened during the 1st half of the game. The question may be pushed as a notification or as a text message. Questions may be more likely to be provided for events in which influencer teams are involved. Upon registration, users may select their favorite team or teams. This will allow quiz questions or prizes to be geared towards the user's interests.

Users are awarded points based on the results of the periodic quiz. Users may also be awarded points based on a subscription that gains them additional points or additional opportunities to earn points. The number of points earned by the user entitles the user to entries in a raffle for club related prizes. The club prize may be tickets to an upcoming club match, signed club apparel, or face-to-face or live chat interactions with club players. In some embodiments, fans may pay money to meet with players directly through the app.

Users to use the platform, to vote for a choice of at least one of a sport event or a live match option. A sport event is any event that can be held relating to the sport such as a fan/player meet and greet, a parade featuring club members or players, a player interview or other event relating to the sport. A live match option can be an option relating to a particular match, which may have been broadcast over the platform. The live match option can be any combination of a man of the match (i.e., the player that most impacted the match), a best goal, a best play, a best comment, or a best broadcast moment. This feature allows users to have a say in the events and moments that are highlighted in the application.

The method further includes allowing users to bid awarded points for a choice of event options. The live event options can include best player over a time period (such as player of the game, player of the week, player of the week, player of the season, etc.), best goal of a time period (such as goal of the game, goal of the week, goal of the month, goal of the season, etc.), best coach over a time period (the match, week, month, season, etc.), or best team over a time period (week, month, season, etc.). This feature allows users to use their points in a competitive and engaging way.

Sponsors can propose special redemption items, diversifying the reward catalog. In tandem with more advanced trivia and point-tracking, leaderboards will categorize fans based on daily, weekly, or monthly performance. Visibility of top scorers fosters a competitive environment, motivating continued engagement. Meanwhile, community or club-level leaderboards can spotlight dedicated superfans. The method also includes allowing users to predict a live event option. This feature allows users to engage with the application and the club in a predictive and strategic way.

At least one of the clubs may sponsor a raffle and provide the club prize. A schedule may be provided for clubs to sponsor raffle prizes. The method may also include a weekly schedule of quiz challenges, which includes having a daily quiz on Monday through Thursday, announcing winners on Friday, and awarding prizes on Saturday. The method may also include broadcasting the raffle live on a media channel.

In some embodiments, the club is a member of at least one league. Each league has a league page, and users who are fans of a club in the league are indexed as fans of the league.

Players who play for a club may apply for a player user account that is an official account for players that play for a club. Similarly, influencers may enroll as an influencer user by applying for an influencer account. Player and influencer users are vetted by administrators before being granted a player or influencer account. Influencers may be enabled to live stream during matches for a club and link the live stream to the club page of the club. The influencer may create questions for viewers of the live stream and award points for correct responses. In some embodiments, the league page has a league user that is an official account that manages the league profile, uploads league video and news, and is enabled to follow or unfollow users on behalf of the league.

The platform may provide an integrated biometric identification system. This subsystem allows users to upload palm print or other biometric data to their platform profiles, facilitating seamless stadium entry for upcoming matches and sports-related events while maintaining strict privacy controls. Biometric data may include facial recognition, fingerprint scanning, iris scanning, voice recognition, retina scanning, cardiac signature or other biometric data to interact with secure systems to verify a user's identity. Each of these methods offers different balances of security, convenience, and user acceptance. The platform could implement a multi-modal approach where different combinations of biometrics are required depending on the security level needed for various venue areas or premium experiences.

The biometric subsystem employs proprietary algorithms for template matching that significantly reduce false acceptance and rejection rates compared to conventional systems while ensuring compliance with applicable data protection regulations. The captured data will be converted into a secure token, effectively serving as a portable, digital ID. Stadium gates may recognize these biometric tokens for user authentication. Fans would no longer juggle tickets or passes; scanning a face or palm suffices.

An integrated identity system may allow clubs to tie in-app activities—like trivia engagement—to real stadium attendance, broadening data collection, revealing patterns in fan loyalty and event participation. Sponsors, too, can track how many fans engaged with promotions both online and on-site. By correlating biometric check-ins, in-app social metrics, and event-based data (like quizzes played), the platform can accumulate robust fan profiles. Marketers can analyze user footprints from early-season speculation to actual ticket usage. Clubs, leagues, and sponsors receive a specialized interface to glean real-time metrics: from average fan engagement times to the success rates of sponsor campaigns. These insights inform marketing strategies and fortify security approaches.

The Back-Engine includes a robust educational content repository with versioning control and a trivia system database that is specifically localized to domestic sports markets. Questions for this trivia system can either be manually inputted by stakeholders or generated through an artificial intelligence module capable of natural language processing for sports-specific terminology, context-aware question formulation, and difficulty calibration that adapts to user engagement metrics. Primary stakeholders including sports teams, clubs, and leagues can perform all such configurations through the Back-Engine's administrative controls.

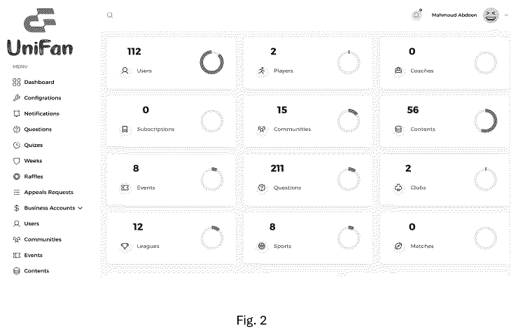

The system implements a technical framework for user communities, defined as digital associations of users organized around shared interests. Referring to FIG. 2, certain aspects of the Back-Engine functionality are selectively exposed to community members through what is termed a “mini-back-engine,” enabling user-generated content creation through controlled interfaces. This allows users to formulate their own questions and interactive challenges for their respective communities, enhancing engagement and personalization of the platform experience.

The fundamental technical architecture of the platform is built upon a centralized database that maintains relational data between fans, stakeholders, and sports entities. This database employs normalized data structures to reduce redundancy while maximizing data integrity, implements efficient indexing strategies for rapid query processing during high-volume usage periods, and utilizes partitioning techniques based on geographical and sports-category parameters for optimized performance. The platform also incorporates standardized API endpoints that facilitate integration with existing stadium management systems, ticketing platforms, government identification databases where legally permissible, sports analytics systems, and broadcasting networks.

The implementation of the platform produces several technical advantages, including reduced authentication processing time at venue entry points, increased data consistency across multiple sports stakeholders, enhanced user engagement through personalized content delivery, improved operational efficiency for sports organizations, and reduced administrative overhead for multi-regional sports governance. Through its technical implementation, the platform successfully addresses the limitations of existing systems by providing a comprehensive service that connects fans with sports stakeholders in a manner specifically tailored to domestic market dynamics while maintaining robust security and privacy controls. This method enhances fan engagement by providing relevant club information, quizzes, and opportunities to win club prizes. The method also allows for increased interaction between fans, clubs, players, and influencers.

The platform may be integrated with other hardware including wearables, VR headsets, and partner sports-tech solutions. This multi-channel presence allows fans to remain plugged in whether they're in a physical stadium, browsing at home, or on-the-go. Verified attendance plus real-time engagement data yields tangible sponsorship ROI. Clubs can open direct revenue avenues via in-app merchandise drops, exclusive digital items, or loyalty-based membership tiers. For sponsors, hyper-targeted campaigns can convert engaged fans into brand advocates.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

I claim:

1. A method of driving fan interactions with a sports club, the method comprising the acts of:
providing a mobile application having at least one club page, each club page having information relevant to a club;
allowing a plurality of users to enroll to use the application;
indexing each user as a fan of at least one of the clubs;
providing a periodic quiz based on information relevant to the club to each user that is indexed as a fan of the club;
awarding points to users based on the results of the periodic quiz;
holding a raffle for club prizes with entries based on the points.

2. The method of claim 1 wherein the at least one club is a member of at least one league and wherein each league has a league page, the method further comprising indexing the users who are fans of a club in the league as fans of the league.

3. The method of claim 1 wherein the information relevant to the club is related to at least one of players that play for the club, personnel of the club, history of the club, recent game results for the club, and club branding and marketing materials.

4. The method of claim 1 wherein the club page has a club user that is an official account that manages the club profile, uploads club video and news and is enabled to follow or unfollow users on behalf of the club.

5. The method of claim 1 further comprising allowing a sports club super fans to enroll as influencer users by applying for an influencer account.

6. The method of claim 1 further comprising allowing at least one influencer to enroll as influencer users by applying for an influencer account.

7. The method of claim 1 further comprising player users that are official accounts for players that play for a club.

8. The method of claim 1 further comprising enabling at least one influencer to live stream during matches for a club and linking the live stream to the club page of the club.

9. The method of claim 6 wherein the at least one influencer is enabled to create questions for viewers of the live stream and award points for correct responses.

10. The method of claim 2 wherein the league page has a league user that is an official account that manages the league profile, uploads league video and news and is enabled to follow or unfollow users on behalf of the league.

11. The method of claim 1 wherein at least one of the clubs sponsors a raffle and provides the club prize.

12. The method of claim 11 further comprising providing a schedule for clubs to sponsor raffle prizes.

13. The method of claim 1 further comprising allowing users to pay for extra quiz questions.

14. The method of claim 1 further comprising generating quiz content through artificial intelligence machine learning.

15. The method of claim 1 further comprising broadcasting the raffle live on a media channel.

16. The method of claim 1 further comprising allowing users to vote for a choice of at least one of a sport event or a live match option.

17. The method of claim 16 wherein the live match option is at least one of a man of the match, a best goal, a best play, a best comment, or a best broadcast moment.

18. The method of claim 1 further comprising allowing users to bid awarded points for a choice of event options.

19. The method of claim 18 wherein the live event options include best player over a time period, best goal of a time period, best coach over a time period, or best team over a time period.

20. The method of claim 1 further comprising allowing users to predict a live event option.
